(19) United States
(12) Patent Application Publication
(10) Pub. No.: US 2020/0131340 A1
(43) Pub. Date: Apr. 30, 2020

(54) CUT-RESISTANT THERMOPLASTIC COMPOSITION

(71) Applicant: BASF SE, Ludwigshafen am Rhein (DE)

(72) Inventor: Mark Paul Kujawski, Grosse Pointe Wood, MI (US)

(21) Appl. No.: 16/500,828

(22) PCT Filed: Apr. 6, 2018
(86) PCT No.: PCT/US2018/026435

§ 371 Date: Oct. 4, 2019

Related U.S. Application Data
(60) Provisional application No. 62/482,442, filed on Apr. 6, 2017.

(51) Int. Cl. C08K 7/18; C08K 3/34

(52) U.S. Cl. CPC C08K 7/18; B26D 7/12; C08K 2201/005; C08K 3/34

(57) ABSTRACT

A cut-resistant thermoplastic composition comprises a polymer and ceramic microspheres. The ceramic microspheres have a D90 particle size of from about 20 to about 80 μm, a D50 particle size of from about 1 to about 15 μm, and/or a D10 particle size of about 1 μm. The ceramic microspheres are present in the cut-resistant thermoplastic composition in an amount of from about 5 to about 50 weight percent, based on 100 parts by weight of said thermoplastic composition.

### FIELD OF THE INVENTION

The instant invention generally relates to a cut-resistant thermoplastic composition, an article formed therefrom, and a method of using the article.

### DESCRIPTION OF THE RELATED ART

Cut-resistant thermoplastic materials are used in a variety of applications in a variety of industries. For example, cut-resistant thermoplastic materials are used in safety products such as protective clothing, cut-resistant gloves, and safety glasses. As another example, cut-resistant thermoplastic materials are used in various commercial and industrial products such as cutting boards and conveyor belts.

In the food industry, meat packing plants and food processors use conveyor belts to transfer meat down an assembly line where butchers cut, separate, and remove certain cuts of meat. During the butchering and packing process, the conveyor belt is subject to repeated impacts and physical stresses from knives, guillotines, the food product, cleaning products and processes, and inherent physical stresses associated with the operation of a manufacturing line. Repeated contact with knives and other sharp objects in combination with the other physical stresses placed on a conveyor belt can cause small pieces of conveyor belt to dislodge or break away from the conveyor belt causing contamination and potential product recalls, and eventually cause failure of the conveyor belt, e.g. tearing or breaking of the conveyor belt. Further, repeated contact between the conveyor belt and cutting equipment, such as knives, guillotines, and die, can dull the blades of the cutting tools, which increases the cutting force required, thereby placing additional physical stresses on the operator and/or the cutting equipment.

From a health and cleanliness perspective, the pieces of conveyor belt can find their way into the packaged meat, which poses commercial and regulatory issues. In fact, FDA auditors look for potential sources of food contamination (such as pieces of a conveyor belt) during audits at food processors. Additionally, cuts and gashes on conveyor belts caused by repeated contact between the conveyor belt and cutting equipment are difficult to clean and thus may require additional cleaning time and/or chemicals. From a manufacturing perspective, the pieces of conveyor belt can work their way into the manufacturing equipment on the manufacturing line such as rollers, motors, etc., which can cause equipment issues and down time. In some cases, the lost pieces can even cause the conveyor belt to fail, which results in down time and expensive replacement costs.

Further, known cut-resistant thermoplastic compositions are typically rigid because rigid polymers (e.g. high molecular weight polyoxymethylene) are required to obtain sufficient cut-resistance. Because of the rigidity of known cut-resistant thermoplastic compositions, conveyor belts typically require a modular design. Modular designs include discrete belt sections which have teeth. The teeth of the belt sections intermesh to link the belt sections together and form a continuous conveyor belt. Modular designs are necessary because the belt sections hinge at the beginning and end of the conveyor line rather than bend. However, the spaces between intermeshing teeth of the belt sections collect waste, provide a location for bacteria to grow, and are difficult to clean.

Accordingly, there remains an opportunity for improved cut-resistant thermoplastic materials.

### SUMMARY OF THE INVENTION AND ADVANTAGES

A cut-resistant thermoplastic composition comprises a polymer and ceramic microspheres. The ceramic microspheres have a D90 particle size of from about 20 to about 80 μm, a D50 particle size of from about 1 to about 15 μm, and/or a D10 particle size of about 1 μm. The ceramic microspheres are present in the cut-resistant thermoplastic composition in an amount of from about 5 to about 50 weight percent, based on 100 parts by weight of said thermoplastic composition.

A method of cutting an object on an article formed from the cut-resistant thermoplastic composition is also disclosed. The method comprises the steps of providing the article comprising the thermoplastic composition, and cutting the object on the article with a blade.

The cut-resistant thermoplastic composition of the subject disclosure exhibits excellent physical properties, such as tensile strength, tear strength, elongation at break, elastic modulus, flexural modulus, and cut-resistance over a wide range of temperatures. In some embodiments, the cut-resistant thermoplastic composition exhibits excellent flexibility over a wide range of temperatures and can thus be extruded into a continuous sheet capable of bending at the beginning and end of a conveyor line, thus eliminating the need for modular conveyor belts and the problems associated with modular conveyor belts.

In addition to providing cut-resistance, the ceramic microspheres included in the cut-resistant thermoplastic composition reduce the rate of blade dulling upon contact between the blade (e.g. from cutting equipment such as a knife or guillotine) and an article comprising the thermoplastic composition, thereby reducing physical stresses on the operator and/or the cutting equipment and further elongating the life of articles formed with the cut-resistant thermoplastic composition.

### BRIEF DESCRIPTION OF THE FIGURES

Other advantages of the present disclosure will be readily appreciated, as the same becomes better understood by reference to the following detailed description when considered in connection with the accompanying drawings wherein:

FIG. 1 is an illustration of a cross-sectional side view of a blade in contact with the surface of an article formed from a prior art thermoplastic composition.

FIG. 2 is an illustration of a cross-sectional side view of a blade in contact with the surface of an article formed from a thermoplastic composition in accordance with the subject disclosure.

FIG. 3 is a schematic that illustrates a cut-resistance test method.

FIG. 4 is a schematic that illustrates a drag-force test method.

FIGS. 1-4 are exemplary in nature and are not drawn to scale and are thus not intended to represent the relative sizes of the various components of the subject disclosure.

### DETAILED DESCRIPTION OF THE INVENTION

Referring to the Figures wherein like numerals indicate like or corresponding parts throughout the several views a cut-resistant thermoplastic composition (“thermoplastic composition”) generally shown at 10. The thermoplastic composition 10 and an article formed therefrom can be used in a variety of applications in a variety of industries. For example, the thermoplastic composition 10 and articles formed therefrom can be used to form safety products such as protective clothing, cut- resistant gloves, and safety glasses. As another example, the thermoplastic composition 10 and articles formed therefrom can be used in various commercial and industrial products such as cutting boards and conveyor belts.

In many embodiments, the thermoplastic composition 10 is used to form commercial and industrial products such as cutting boards and conveyor belts. In such applications, the products exhibit excellent cut-resistance and minimize the rate of dulling of a blade 16 associated with contact between the blade 16 and the product, e.g. the conveyor belt.

### The Cut-Resistant Thermoplastic Composition

### Polymer

The thermoplastic composition 10 includes one or more of the polymer. The polymer is selected from elastomers, thermoplastics, thermoplastic elastomers, and combinations thereof.

The polymer can be a thermoplastic polymer or a thermosetting polymer. Thermoplastics have a relatively high molecular weight and molecular chains that associate through intermolecular forces, which weaken rapidly with increased temperature, and thus melt. As such, thermoplastics may be reshaped by heating and are typically used to produce parts by various polymer processing techniques such as injection molding, compression molding, calendering, and extrusion. In contrast to thermoplastics, thermosets form irreversible chemical bonds when cured and thus do not melt, but decompose.

In many embodiments, the polymer is a thermoplastic polymer (thermoplastic). The thermoplastic can be an amorphous, crystalline, or semi- crystalline polymer. Generally, crystalline polymers have a relatively sharp melting point, have a more ordered arrangement of molecular chains, and require higher temperatures to flow well when compared to amorphous polymers. Generally, amorphous polymers have no true melting point and soften gradually, have a more random orientation of molecular chains, and do not flow as easily as amorphous polymers. In some embodiments, the thermoplastic composition 10 includes thermoplastic elastomer, or a combination of crystalline and amorphous thermoplastic polymers, and is therefore semi-crystalline.

Various non-limiting examples of suitable elastomers include natural rubber (natural polyisoprene), synthetic polyisoprene, polybutadiene, chloroprene rubber, butyl rubber, halogenated butyl rubber, styrene-butadiene rubber, nitrile rubber, ethylene propylene rubber, ethylene propylene diene rubber, epichlorohydrin rubber, polyacrylic rubber, silicone rubber, fluorosilicone rubber, fluoroelastomer, perfluoroelastomer, polyether block amides, chlorosulfonated polyethylene, and ethylene-vinyl acetate.

Various non-limiting examples of suitable thermoplastics and thermoplastic elastomers include polyolefins, polyolefin elastomers, polyvinylchlorides (PVC), polyamides (PA), styrenic elastomers, thermoplastic vulcanate elastomer (TPV), fluoropolymers, silicones, polyesters, polyoxymethylenes (POM), thermoplastic polyurethanes (TPU), and combinations thereof. In some preferred embodiments, the polymer is selected from thermoplastic polyurethane, polyoxymethylene, polyalkylene terephthalate, and combinations thereof.

Suitable, non-limiting examples of polyolefins include polyethylene (PE), polypropylene (PP), polymethylpentene (PMP), and polybutene-1(PB-1). Further suitable, non-limiting examples of polyolefin elastomers include polyisobutylene (PIB), ethylene propylene rubber (EPR), ethylene propylene diene monomer rubber (EPDM).

Suitable, non-limiting examples of polyamides include PA11, PA12, PA610, PA612, PA1010, PA6, PA66, PA1110T, PA1212T, and combinations thereof.

Suitable, non-limiting examples of thermoplastic styrenic elastomers include styrenic block copolymer with ethylene, propylene, butadiene, isoprene units, or a TPS (e.g. SBS, SEBS, and SEPS). Thermoplastic styrenic elastomers are typically based on A-B-A type block structure where A is a hard phase and B is an elastomer.

Suitable, non-limiting examples of particular fluoropolymers include polytetrafluoroethylene (PTFE), fluorinated ethylene propylene (FEP), perfluoroalkoxy (PFA), and ethylenetetrafluoroethylene (ETFE).

Suitable, non-limiting examples of polyesters include polyglycolide or polyglycolic acid (PGA), polylactic acid (PLA), polycaprolactone (PCL), polyhydroxyalkanoate (PHA), polyhydroxybutyrate (PHB), copolymer polyethylene adipate (PEA), polybutylene succinate (PBS), poly(3-hydroxybutyrate-co-3-hydroxyvalerate) (PHBV), semi-aromatic copolymer polyethylene terephthalate (PET), polybutylene terephthalate (PBT), polytrimethylene terephthalate (P11), polyethylene naphthalate (PEN), copolyester compounds (TPE-E), and Vectran. The polyester can be selected from a polyalkylene terephthalate such as polyethylene terephthalate, polybutylene terephthalate, polytrimethylene terephthalate, polyethylene naphthalate, polyethylene adipate, polyhydroxylalkanoate, polyhydroxyl butyrate, poly(3-hydroxybutyrate-co-3-hydroxyvalerate), polyglycolide, polylactic acid, the polycondensation product of 4-hydroxybenzoic acid and 6-hydroxynaphthalene-2-carboxylic acid, and polycaprolactone. In one particular embodiment, the polymer is further defined as a semi-crystalline thermoplastic polyester including, but not limited to, polyethylene terephthalate, polybutylene terephthalate, polytrimethylene terephthalate, polyethylene terephthalate-co-isophthalate, and combinations thereof. In another particular embodiment, the polymer is polybutylene terephthalate.

In various embodiments, the polyester has: a weight average molecular weight of greater than about 10,000, or greater than about 25,000, or from about 10,000 to about 1,000,000, or from about 50,000 to about 750,000, or from about 75,000 to about 500,000 g/mol; a tensile modulus at 23° C. of from about 350 to about 14,000, or about 700 to about 7,000, or from about 1,500 to about 3,500 MPa as determined by ISO 527-1/-2; a tensile strength (yield stress) of from about 15 to about 150, or from about 35 to about 75 MPa at 23° C. as determined by ISO 527-1/-2; and/or an elongation (yield strain) at 23° C. of from about 1 to about 20, or from about 2 to about 10, or from about 3 to about 5% as determined by IS 527-1/-2. Examples of suitable polyesters that may be used include, but are not limited to, ULTRADUR® polybutylene terephthalates, commercially available from BASF Corporation. ULTRADUR® thermoplastic polyester from BASF is a semi-crystalline, thermoplastic polyester based on polybutylene terephthalate (PBT) which can be unreinforced (not filled) or reinforced (filled, e.g. glass filled).

Suitable, non-limiting examples of an acetal polymer is polyoxymethylene. The acetal polymer may be further defined as a homopolymer, a copolymer, or a mixture of homopolymers and copolymers. Typically, the acetal polymer is further defined as a polyoxymethylene. The polyoxymethylene may be further defined as a homopolymer, a copolymer, or a mixture of homopolymers and copolymers. The polyoxymethylene may be further defined as a polyoxymethylene homopolymer (—(—O—CH₂—)ₙ—) wherein n may be any number greater than 1. As is known in the art, homopolymers of polyoxymethylene are typically synthesized by polymerizing anhydrous formaldehyde by anionic catalysis and then stabilized by reaction with acetic anhydride. As another example, the polyoxymethylene may be a polyoxymethylene copolymer. As is also known in the art, copolymers of polyoxymethylene may be synthesized by converting formaldehyde to trioxane via acid catalysis and then reacting the trioxane with dioxolane or ethylene oxide to form the copolymer using acid catalysts.

In various embodiments, the polyoxymethylene has: a weight average molecular weight of greater than about 10,000, or greater than about 25,000, or from about 10,000 to about 1,000,000, or from about 50,000 to about 750,000, or from about 75,000 to about 500,000 g/mol; a tensile strength (yield stress) of from about 20 to about 200, or from about 40 to about 100 MPa at 23° C. as determined by ISO 527-1/-2; an elongation (yield strain) at 23° C. of from about 1 to about 40, or from about 2 to about 20, or from about 4 to about 10% as determined by ISO 527-1/-2; and/or a tensile modulus at 23° C. of from about 500 to about 16,000, or about 1,000 to about 8,000, or from about 2,000 to about 4,000 MPa as determined by ISO 527-1/-2. Examples of suitable polyoxymethylenes that may be used include, but are not limited to, ULTRAFORM® polyoxymethylenes, commercially available from BASF Corporation.

In a preferred embodiment, the thermoplastic composition 10 comprises a thermoplastic polyurethane elastomer (TPU) which may also be described by those skilled in the art as TPU, thermoplastic polyurethane, or TPE-U's. Of course, it is contemplated that the thermoplastic composition 10 may include one or more TPU's. Generally, the TPU's comprise the reaction product of one or more polyols, one or more chain extenders (e.g. diols), and an isocyanate component. TPU's typically include linear segmented polymeric blocks including hard and soft segments. Without intending to be bound by any particular theory, it is believed that the soft segments are of low polarity and form an elastomer matrix which provides elastic properties to the thermoplastic polyurethane. The hard segments are believed to be shorter than the soft segments, to be of higher polarity, and act as multifunctional tie points that function both as physical crosslinks and reinforcing fillers. The physical crosslinks are believed to disappear when heat is applied, thus allowing the thermoplastic polyurethanes to be used in the variety of processing methods.

TPU's are known in the art for toughness, low temperature flexibility, strength, abrasion resistance, transparency, and chemical resistance. These physical properties can be tailored to different end uses by adjusting a nature and an amount of the isocyanate, the linear polymer glycol, and/or the low molecular weight diol.

The TPU may be further defined as a polyether thermoplastic polyurethane (i.e., a polyether based TPU), a polyester thermoplastic polyurethane (i.e., a polyester based TPU), or a combination of a polyether thermoplastic polyurethane and a polyester thermoplastic polyurethane. That is, TPU may be further defined as including or being the reaction product of an isocyanate and a polyether polyol, a polyester polyol, an aliphatic or olefinic polyol or a combination of these polyols. Alternatively, the TPU may be further defined as a multi-block copolymer produced from a poly-addition reaction of an isocyanate with a linear polymeric glycol (e.g. having a weight average molecular weight of from about 500 to about 8,000 g/mol), low molecular weight diol (e.g. having a weight average molecular weight of from about 50 to about 600 g/mol), and or/polyol. Typically, TPU's can be obtained by varying a ratio of hard segments and soft segments, as described above. Physical properties such as Shore hardness, along with modulus, load-bearing capacity (compressive stress), tear strength, and specific gravity, typically increases as a ratio of hard segments to soft segments increases.

For purposes of the subject disclosure, a “polyester-based” TPU is a TPU that includes at least two ester groups present therein and/or is formed from a reactant that includes a polyester bond. Likewise, also for purposes of the instant application, a “polyether-based” TPU is a TPU that includes at least two ether groups present therein and/or is formed from a reactant that includes a polyether bond. It is to be appreciated that for both polyester-based and polyether-based TPU's, reactants can be used to form the TPU's that do not include polyester or polyether groups therein. Further, it is also to be appreciated that suitable TPU's for purposes of this disclosure are not limited to polyester-based or polyether-based TPU's, and that other TPU's may also be suitable that do not include ether or ester groups present therein. When more than one TPU is included in the thermoplastic composition, greater than one TPU meets the description of the TPU's set forth in this disclosure, and the additional TPU's are not limited to any particular TPU, but typically include a polyether-based TPU and/or a polyester-based TPU.

In many embodiments, the TPU further includes the reaction product of a chain extender, in addition to the polyester polyols or polyether polyols in the polyester-based or polyether-based TPU's, respectfully. In other embodiments, the TPU may comprise the reaction product of the chain extender and the isocyanate in the absence of polyester polyols and/or polyether polyols. Suitable chain extenders may be selected from the group of, but are not limited to, diols including ethylene glycol, propylene glycol, butylene glycol, 1,4-butanediol, butenediol, butynediol, xylylene glycols, amylene glycols, 1,4-phenylene-bis-beta-hydroxy ethyl ether, 1,3-phenylene-bis-beta-hydroxy ethyl ether, bis-(hydroxy-methyl-cyclohexane), hexanediol, and thiodiglycol; diamines including ethylene diamine, propylene diamine, butylene diamine, hexamethylene diamine, cyclohexalene diamine, phenylene diamine, tolylene diamine, xylylene diamine, 3,3′-dichlorobenzidine, and 3,3′-dinitrobenzidine; alkanol amines including ethanol amine, aininopropyl alcohol, 2,2-dimethyl propanol amine, 3-aminocyclohexyl alcohol, and p-aminobenzyl alcohol; and combinations of any of the aforementioned chain extenders.

In one embodiment, the TPU is a polyester thermoplastic polyurethane and includes the reaction product of a polyester polyol, an isocyanate component, and a chain extender. Suitable polyester polyols are typically produced from a reaction of a dicarboxylic acid and a glycol having at least one primary hydroxyl group. Suitable dicarboxylic acids include, but are not limited to, adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. Glycols that are suitable for use in producing the polyester polyols include, but are not limited to, ethylene glycol, butylene glycol, hexanediol, bis(hydroxymethylcyclohexane), 1,4-butanediol, diethylene glycol, 2-methyl-propanediol, 3-methyl-pentanediol, 2,2-dimethyl propylene glycol, 1,3-propylene glycol, and combinations thereof. Specific examples of suitable polyester thermoplastic polyurethanes that can be used in this invention include, but are not limited to, ELASTOLLAN® polyester thermoplastic polyurethanes which are commercially available from BASF Corporation.

In an alternative embodiment, the TPU is a polyester thermoplastic polyurethane and includes the reaction product of a suitable chain extender, an isocyanate component, and a polymeric polyol. Suitable chain extenders are disclosed above. Specific examples of suitable polyester thermoplastic polyurethanes that can be used in this invention include, but are not limited to, ELASTOLLAN® polyester thermoplastic polyurethanes which are commercially available from BASF Corporation.

In a further embodiment, the TPU is a polyether thermoplastic polyurethane and includes the reaction product of a polyether polyol, an isocyanate component, and a chain extender. Suitable polyether polyols include, but are not limited to, polytetramethylene glycol, polyethylene glycol, polypropylene glycol, and combinations thereof. In yet another embodiment, the TPU is a polyether thermoplastic polyurethane and includes the reaction product of a chain extender and an isocyanate component. It is to be understood that any chain extender known in the art can be used by one of skill in the art depending on the desired properties of the thermoplastic polyurethane. Specific examples of suitable polyether thermoplastic polyurethanes that may be used in this invention include, but are not limited to, ELASTOLLAN polyether thermoplastic polyurethanes which are commercially available from BASF Corporation.

In a further embodiment, the TPU is an aliphatic or olefinic thermoplastic polyurethane and includes the reaction product of an aliphatic or olefinic thermoplastic polyol, an isocyanate component and a chain extender. Suitable polyether polyols include, but are not limited to, hydrogenated polybutadiene or non-hydrogenated polybutadiene, and combinations thereof or in combination with polyester and/or polyether polyol. It is to be understood that any chain extender known in the art can be used by one of skill in the art depending on the desired properties of the thermoplastic polyurethane.

Typically, the polyether, polyester, aliphatic or olefinic polyols used to form the TPU have a weight average molecular weight of from about 600 to about 3,000 g/mol. However, the polyols are not limited to this molecular weight range. In one embodiment, starting materials used to form the TPU (e.g., a linear polymeric glycol, a low molecular weight diol, and/or a polyol) have average functionalities of approximately 2. For example, any pre-polymer or monomer can have two terminal reactive groups to promote formation of high molecular weight linear chains with no or few branch points in the TPU.

The isocyanate component that is used to form the TPU typically includes, but is not limited to, isocyanates, diisocyanates, polyisocyanates, and combinations thereof. The isocyanate component can include one or more different isocyanates. In one embodiment, the isocyanate component includes an n-functional isocyanate. In this embodiment, n is a number typically from about 2 to about 5, more typically from about 2 to about 4, still more typically of from about 2 to about 3, and most typically about 2. It is to be understood that n may be an integer or may have intermediate values from about 2 to about 5. The isocyanate component typically includes an isocyanate selected from the group of aromatic isocyanates, aliphatic isocyanates, and combinations thereof. In another embodiment, the isocyanate component includes an aliphatic isocyanate such as hexamethylene diisocyanate (HDI), dicyclohexyl-methyl-diisocyanate (H12MDI), isophoron-diisocyanate, and combinations thereof. If the isocyanate component includes an aliphatic isocyanate, the isocyanate component may also include a modified multivalent aliphatic isocyanate, i.e., a product which is obtained through chemical reactions of aliphatic diisocyanates and/or aliphatic polyisocyanates. Examples include, but are not limited to, ureas, biurets, allophanates, carbodiimides, uretonimines, isocyanurates, urethane groups, dimers, trimers, and combinations thereof. The isocyanate component may also include, but is not limited to, modified diisocyanates employed individually or in reaction products with polyoxyalkyleneglycols, diethylene glycols, dipropylene glycols, polyoxyethylene glycols, polyoxypropylene glycols, polyoxypropylenepolyoxethylene glycols, polyesterols, polycaprolactones, and combinations thereof.

Alternatively, the isocyanate component can include an aromatic isocyanate. If the isocyanate component includes an aromatic isocyanate, the aromatic isocyanate typically corresponds to the formula R′(NCO)_{z} wherein R′ is aromatic and z is an integer that corresponds to the valence of R′. Typically, z is at least two. Suitable examples of aromatic isocyanates include, but are not limited to, tetramethylxylylene diisocyanate (TMXDI), 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and combinations thereof. Alternatively, the aromatic isocyanate may include a triisocyanate product of in- TMXDI and 1,1,1-trimethylolpropane, a reaction product of toluene diisocyanate and 1,1,1-trimethyolpropane, and combinations thereof. In one embodiment, the isocyanate component includes a diisocyanate selected from the group of methylene diphenyl diisocyanates, toluene diisocyanates, hexamethylene diisocyanates, H12MDIs, and combinations thereof. The isocyanate component can also react with the polyol and/or chain extender in any amount, as determined by one skilled in the art.

The isocyanate component may react with the polyol and/or chain extender in any amount, as determined by one skilled in the art. Typically, the isocyanate and the polyol and/or chain extender are reacted at an isocyanate index of from about 80 to about 130, alternatively from about 90 to about 120, more typically from about 95 to about 105, and most typically from about 105 to about 110.

Various additives can be used to form the polymer, e.g. the TPU. Suitable additives include, but are not limited to, anti-foaming agents, processing additives, plasticizers, chain terminators, surface-active agents, adhesion promoters, flame retardants, anti-oxidants, water scavengers, fumed silicas, dyes, ultraviolet light stabilizers, fillers, acidifiers, thixotropic agents, transition metals, catalysts, blowing agents, surfactants, cross-linkers, inert diluents, and combinations thereof. Some particularly suitable additives include, but are not limited to, carbodiimides to reduce hydrolysis, hindered phenols and hindered amine light stabilizers to reduce oxidation and yellowing, benzotriazoles to increase UV light stabilization, glass fillers, and salts of sulfonic acid to increase antistatic properties of the TPU composition. The additive(s) may be included in any amount as desired by those of skill in the art. In various embodiments, the TPU has: a weight average molecular weight of greater than about 25,000, or greater than about 2,000,000, or from about 50,000 to about 1,000,000, or from about 100,000 to about 500,000 g/mol; a tensile strength (yield stress) of from about 10 to about 300, or from about 20 to about 150, or from about 40 to about 75 MPa at 23° C. as determined by ASTM D412; an elongation (yield strain) at 23° C. of from about 125 to about 600, or from about 250 to about 500% as determined by ASTM D412; and/or a tensile modulus at 23° C. of from about 50 to about 350, or from about 100 to about 700 MPa at 23° C. as determined by ASTM D412. Examples of suitable TPU's that may be used include, but are not limited to, ELASTOLLAN® TPU's, commercially available from BASF Corporation.

The polymer is typically present in the thermoplastic composition 10 in an amount of from about 5 to about 95, or from about 40 to about 90, or from about 60 to about 85, parts by weight per 100 parts by weight of the thermoplastic composition 10. The amount of the polymer included in the thermoplastic composition 10 may vary outside of the ranges above, but is typically both whole and fractional values within these ranges. In other words, the polymer typically can have any value or range of values therebetween within the range of from about 5 to about 95, based on 100 parts by weight of the thermoplastic composition 10. Further, it is to be appreciated that more than one type of polymer may be included in the thermoplastic composition 10, in which case the total amount of all polymer included is within the above ranges.

### Ceramic Microspheres

The thermoplastic composition 10 includes microspheres 12. The microspheres 12 may be solid or hollow. Typically, the microspheres 12 are solid and spherical (or round) in shape. In some embodiments, the microspheres 12 have a shape other than round, e.g. having an anisotropic, irregular, faceted shape. That is, it is to be understood that in some embodiments the microspheres 12 are not always spherical or round. In some embodiments, the size of the microspheres 12 ranges from nanometers to micrometers. In other embodiments, the size of the microspheres 12 ranges from micrometers to centimeters. The microspheres 12 comprise, consist essentially of, or consist of metal, polymer, ceramic, and/or glass.

In some embodiments, the microspheres 12 have a hardness equal to or greater than that of the cutting material (e.g. metal) of the blade 16. In some such embodiments, the microspheres 12 could comprise metal or ceramic. In other embodiments, the microspheres 12 have a hardness less than that of the cutting material, but still exhibit excellent cut-resistance. In some such embodiments, the microspheres 12 could comprise an aramid (e.g. poly-paraphenylene terephthalamide) or fiberglass. In such embodiments, the aramid may be any known in the art but is typically further defined as an AABB polymer, sold under tradenames such as NOMEX®, KEVLAR®, TWARON® and/or NEW STAR™.

In many embodiments, the ceramic microspheres 12 are hard, high-density spherical micron scale particles comprising alkali alumino silicate ceramic. The microspheres 12 may be solid or hollow. Typically, the microspheres 12 are solid, spherical (or round) in shape, and white in appearance. In many embodiments, the ceramic microspheres 12 have a specific gravity of from about 2.0 to about 2.8, or from about 2.4 to about 2.6, g/cm³.

In some embodiments, the ceramic microspheres 12 may be made of a material that is radiopaque, including, but not limited to, barium sulfate. In such embodiments, conveyor belts can be made with or formed from the thermoplastic composition 10, and any dislodged pieces of conveyor belt can be easily detected by x-ray equipment, preventing contamination of the products, e.g. food, being conveyed on such conveyor belts.

The spherical (round) shape of the ceramic microspheres 12 help: (1) minimize flow induced orientation during molding (i.e., shrinkage of articles formed with the thermoplastic composition 10); and (2) cause a cutting edge of the blade 16 (e.g. the metal blade 16 of cutting equipment such as a knife or guillotine) to slide around the individual ceramic microspheres 12 or to push aside the individual ceramic microspheres 12 when the cutting edge contacts an article formed from the thermoplastic composition 10 (e.g. a conveyor belt). Regarding point (2), the shape and hardness of the ceramic microspheres 12 minimize blunt contact with the blade 16 edge, reduce drag-force during cutting, and can even serve to sharpen the cutting edge upon contact with the article formed from the thermoplastic composition 10.

The particle size of the ceramic microspheres 12 should be small enough to allow the thermoplastic composition 10 to be processable (e.g. extrudable, injection moldable, etc.) and produce a smooth surface 14 (e.g. a show surface), but larger than (have a greater diameter than) the width of the blade 16 edge. It is believed that, if the particles are too small, they will not be deflected out of the way of the blade 16 edge, which results in blunt contact that dulls the blade 16 edge. The blade 16 edge can be on the order of 0.1 μm wide.

Particle size as described herein is with D-Values (D10, D50, and D90). D-values are the diameter of the sphere which divides a sample's mass into a specified percentage when the particles are arranged on an ascending mass basis. For example, the D10 is the diameter at which 10% of the sample's mass is comprised of particles with a diameter less than this value. The D50 is the diameter of the particle that 50% of a sample's mass is smaller than and 50% of a sample's mass is larger than this value. The D90 is the diameter of the particle that 90% of a sample's mass is smaller than and 10% of a sample's mass is larger than this value. Generally, a suitable particle diameter range from the ceramic microspheres 12 is from about 0.1 to about 200 μm. More specifically, in many embodiments, the ceramic microspheres 12 have a particle size distribution in D-Values (D10, D50, and D90) as follows: a D90 particle size of from about 20 to about 80, or from about 5 to about 35, or from about 8 to about 30, or from about 7 to about 11, or from about 13 to about 17, or from about 24 to about 32, or from about 13 to about 30, μm; a D50 particle size of from about 1 to about 15, or from about 2 to about 11, or from about 1 to about 5, or from about 2 to about 12, or from about 2 to about 6, or from about 8 to about 12, μm; and/or a D10 particle size of about 1.

Further, in many embodiments, the ceramic microspheres 12 have a hardness from about 1 to about 15, or from about 1 to about 10, or from about 2 to about 8, on the Mohs hardness scale. The ceramic microspheres 12 should be harder and stronger than the material of the blade 16. The harder ceramic microspheres 12 have a sharpening effect caused by scratching or eroding away the material from the side of the blade 16 edge. This sharpening effect can only happen if blunt contact between the ceramic microspheres 12 and the blade 16 edge is avoided. In many embodiments, the ceramic microspheres 12 have a crush strength of greater than about 4,200 kg/cm², and a hardness of about 6 on the Mohs hardness scale.

The combination of the particle shape, size, and hardness of the ceramic microspheres 12 gives the preferred embodiment of the present invention a unique combination of properties: improved cut-resistance, reduced cutting drag (resistance), and reduced blade 16 dulling.

Referring now to Table 1 below, a comparison of bond types and approximate bond energies for different materials is set forth.

TABLE 1

| | APPROXIMATE BOND ENERGY |
|---|---|
| MATERIAL BONDING | (kcal/mol) |
| Covalent bonds | <170 |
| Metallic bonds | <200 |
| Ionic bonds | <370 |
| Hydrogen bonds | <12 |
| van der Waals | 1-10 |

Embodiments of the blade 16 comprising high strength (e.g. components of knives, guillotines, etc.) which are bound by metallic bonds having a strength of up to 200 kcal/mol can be scratched by ceramic materials (e.g. ceramic microspheres 12) which are bound by ionic bonds having a strength of up to 370 kcal/mol. Without being bound by theory, it is believed that the ceramic microspheres 12 will not cut, crush, or break, but will instead distribute the force of the blade 16 to a larger area of the polymer such that the force is sufficiently reduced and the surface 14 of the thermoplastic composition 10 is prevented from being cut by the blade 16.

Referring now to FIG. 1, a schematic representation of the blade 16 in contact with the prior art/comparative surface 22 of an article formed from a prior art/comparative thermoplastic composition 18 (including plate-like filler 20 and without ceramic microspheres 12) is shown, In FIG. 1, the comparative surface 22 of the comparative thermoplastic composition 18 is cut as force is applied to the blade 16, and the blade 16 contacts the comparative surface 22. The comparative thermoplastic composition 18 includes a plate-like filler 20. As such, blunt contact between the blade 16 and the plate-like filler 20 (or any soft and/or any non-round filler for that matter) occurs at the comparative surface 22 and within the comparative thermoplastic composition 18, causing a significant cut/gap in the comparative thermoplastic composition 18 and significant dulling of the blade 16 and can even cause the portions of the comparative thermoplastic composition 18 to break free.

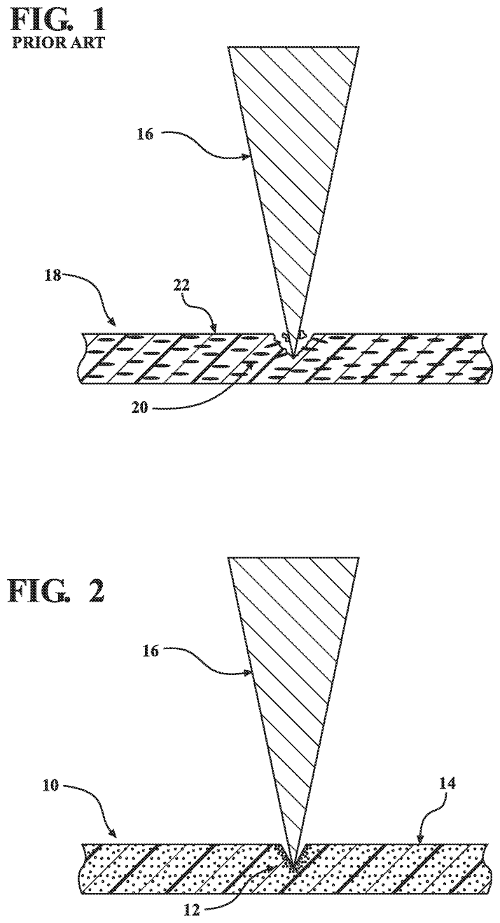

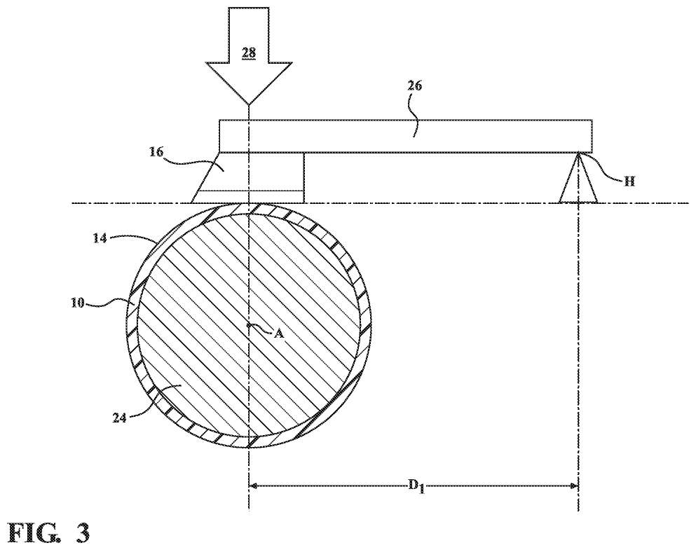

Referring now to FIG. 2, a schematic representation of the blade 16 in contact with the surface 14 of an article formed from the thermoplastic composition 10 of the subject disclosure (including ceramic microspheres 12 as the preferred embodiment) is shown. In some embodiments, the surface 14 of the thermoplastic composition 10 is not cut as force is applied to the blade 16 and the blade 16 contacts the surface 14 because the ceramic microspheres 12 help distribute the force applied by the blade 16 so that the resulting pressure remains below the bond energy of the thermoplastic resin included in the thermoplastic composition 10. That is, the ceramic microspheres 12 provide the thermoplastic composition 10 with improved cut- resistance. In the embodiment of FIG. 2, a sufficient amount of force is applied to the blade 16 such that the surface 14 of the thermoplastic composition 10 is cut as force is applied to the blade 16. In FIG. 2, blunt contact between the blade 16 and the ceramic microspheres 12 is avoided, and thus the sides of the blade 16 are in contact with and sharpened by the ceramic microspheres 12 as the blade 16 enters into the thermoplastic composition 10. To this end, the ceramic microspheres 12 minimize the size of the cut in the thermoplastic composition 10, reduce the drag-force on the blade 16, and at the least minimize dulling of the blade 16, or in some instances sharpen the blade 16.

Further, in view of the bond strengths above, it is believed that the ceramic microspheres 12 will be deflected out of the way of the blade 16 and not cut, which results in contact with the side of the blade 16 (e.g. the side of the knife) which will sharpen the softer metal blade 16. That is, the contact/rubbing of the harder ceramic microsphere against the softer metal blade 16 wall during a cutting motion/contact between the blade 16 and the thermoplastic composition 10 will sharpen the knife similar to a conventional knife sharpener.

The ceramic microspheres 12 are typically present in the thermoplastic composition 10 in an amount of from about 5 to about 95, or from about 10 to about 60, or from about 15 to about 40, parts by weight based on 100 parts by weight of the thermoplastic composition 10. The amount of the ceramic microspheres 12 included in the thermoplastic composition 10 may vary outside of the ranges above, but is typically both whole and fractional values within these ranges. In other words, the ceramic microspheres 12 typically can have any value or range of values therebetween within the range of from about 5 to about 50, based on 100 parts by weight of the thermoplastic composition 10. Further, it is to be appreciated that more than one type of ceramic microspheres 12 may be included in the thermoplastic composition 10, in which case the total amount of all ceramic microspheres 12 included is within the above ranges.

### Additives

The thermoplastic composition 10 may also include, but are not limited to, one or more additives selected from the group of anti-foaming agents, processing additives, waxes, plasticizers, chain terminators, surface-active agents, adhesion promoters, flame retardants, anti-oxidants, water scavengers, fumed silicas, dyes, ultraviolet light stabilizers, fillers, thixotropic agents, transition metals, catalysts, blowing agents, surfactants, cross-linkers, inert diluents, and combinations thereof. Some particularly suitable additives include, but are not limited to, carbodiimides to reduce hydrolysis, hindered phenols and hindered amine light stabilizers to reduce oxidation and yellowing, benzotriazoles to increase IJV light stabilization, glass fillers, and salts of sulfonic acid to increase antistatic properties of the thermoplastic composition 10. The additive(s) may be included in any amount as desired by those of skill in the art.

In some embodiments, the thermoplastic composition 10 comprises a radiopaque filler such as barium sulfate. In such embodiments, conveyor belts can be made with or formed from the thermoplastic composition 10, and any dislodged pieces of conveyor belt can be easily detected by x-ray equipment, preventing contamination of the products, e.g. food, being conveyed on such conveyor belts.

### Properties of the Thermoplastic Composition

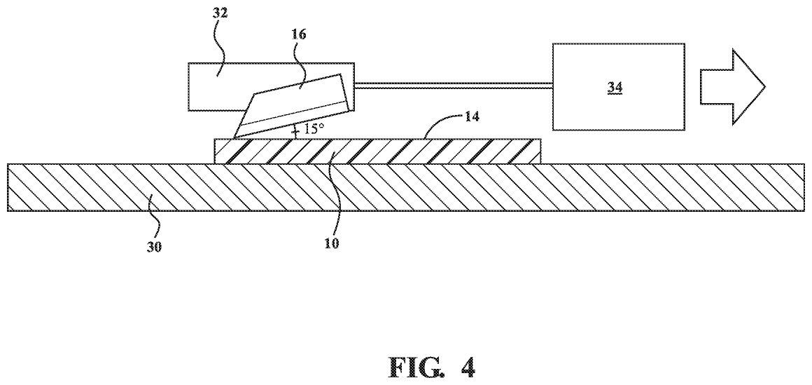

The preferred test methods for evaluating the cut-resistance and drag-force of the thermoplastic composition 10 of the subject disclosure is depicted schematically in FIGS. 3 and 4. However, the preferred test methods are not intended to be limited in scope or exclusive in design, and any person skilled in the art will understand that variants of the preferred test methods are possible without deviating from the basic concepts, and that such variants of the preferred test methods will provide data used to compare two materials tested under the same conditions. It is envisioned that other test parameters and equipment designs can be used including the size of the applied load, cantilever beam length, mandrel diameter, and razor selection as well as other configurations can be easily incorporated into the preferred test methods, and that only the particular configurations of the preferred test methods will be shown and described for purposes of clarity and disclosure and not by way of limitation of scope.

The cut-resistance performance of the thermoplastic composition 10 is evaluated as a direct comparison to conventional thermoplastics currently used in conveyor belt applications, specifically ULTRAFORM® N2320. A first test method (“the cut-resistance test”), schematically illustrated in FIG. 3, is designed to evaluate cut-resistance of materials and the dulling affect they have on the cutting tool, e.g. the blade 16. A second test method (“the drag-force test”), schematically illustrated in FIG. 4, is designed to evaluate the drag-force of a cutting tool, e.g. the blade 16, traveling across the surface 14 of a material.

Referring now to FIG. 3, the cut-resistance test is conducted by first processing the thermoplastic composition 10 into a 2-mm-thick, 6-inch-wide test sheet using a single screw extruder. The test sheet is cut into test strips just long enough to wrap around a 2.5-inch diameter mandrel 24. The test strips are cut in the test sheet at a 45° angle to extrusion direction so that when wrapped around the mandrel 24, the edges of the test strips form a uniform seam with no overlap or gap. Typically, the test strips are placed in a convection oven at 121° C. for 20 minutes to soften the test strips to facilitate wrapping them around the mandrel 24. Once wrapped, the test strips, comprising the thermoplastic composition 10, are secured around the mandrel 24 via taping the edges of the test strip. An unused utility razor blade 16 such as the utility razor replacement from ULINE® (Model #H-595-B) (is attached to the free end of a cantilever beam 26 so that the center of the blade 16 is centered over the mandrel 24 and the test strip. The distance (D₁) between the center axis of the mandrel (A) and the cantilever beam hinge (H) is 6-inches. The hinge is elevated so that the blade 16 is perpendicular to a surface 14 of the test strip. A load of 2 pound-force 28 is applied to the cantilever beam 26 directly above the blade 16 (as shown with the arrow of FIG. 3). Once the apparatus is set-up as described immediately above, the mandrel 24 is rotated 1000 revolutions, at a rate of approximately 15 revolutions per minute (rpm). Once tested, the test strips are removed and analyzed via scanning electron microscopy. The depth of the cut in the test strip and the dulling of the blade 16 is measured. The cut depth is compared to that of the test strips formed with ULTRAFORM® N2320 and tested with the cut- resistance test described above, and a cut-resistance gradient is reported as a percentage. The impact of the testing on the blade 16, e.g. blade dullness, is also analyzed post testing in comparison to blades 16 used when testing test strips formed with ULTRAFORM® N2320.

In a typical embodiment, the thermoplastic composition 10 has a cut-resistance gradient of greater than about 15, about 20, about 30, about 40, about 50, about 60, about 70, about 80, or about 90, %. That is, the average cut-depth for 3 test strips comprising the thermoplastic composition 10 is about 15, about 20, about 30, about 40, about 50, about 60, about 70, about 80, or about 90, % less than the average cut-depth for 3 test strips comprising ULTRAFORM® N2320, with all testing conducted in accordance with the cut-resistance test set forth above.

Referring now to FIG. 4, the drag-force test, which is used to determine the drag-force of a cutting tool, e.g. the blade 16, traveling across the surface 14 of a material, e.g. the thermoplastic composition 10. Test plaques are formed via injection molding the thermoplastic composition 10 into 2 mm thick, 4×4 inch plaques. The plaques are adhered to a horizontal surface 30 using tape. An unused fresh utility razor blade 16 such as the utility razor replacement from ULINE® (Model #H-595-B) is attached to a traversing sled 32. The blade 16 is rotated 15° from horizontal to prevent the leading edge of the blade 16 from snagging a surface 14 of the test plaque. Once assembled, the traversing sled 32 having the blade 16 thereon is pulled across the surface 14 of the test plaque (as shown with the arrow of FIG. 4) at a rate of 2 inches per minute while a force transducer 34 measures the drag-force. The average of 3 drag-force values of the thermoplastic composition 10 being tested is compared to that of the average of 3 drag-force values of test plaques formed with ULTRAFORM® N2320, with all drag-force testing exactly as described above, and a drag-force gradient is reported as a percentage.

In a typical embodiment, the thermoplastic composition 10 has a drag-force gradient of greater than about 15, about 20, about 30, about 40, about 50, about 60, about 70, about 80, or about 90, %. That is, the average drag-force for 3 test plaques comprising the thermoplastic composition 10 is about 15, about 20, about 30, about 40, about 50, about 60, about 70, about 80, or about 90, % less than the average drag- force for 3 test plaques comprising ULTRAFORM® N2320, with all testing conducted in accordance with the drag-force test set forth above.

Typically, the thermoplastic composition 10 has a specific gravity of from about 1.05 to about 1.95, about 1.1 to about 1.85, from about 1.15 to about 1.45, from about 1.1 to about 1.25, from about 1.12 to about 1.2, or from about 1.3 to about 1.5, g/cm³ as determined by ASTM D792. In one embodiment, the thermoplastic composition 10 has a density of about 1.15 g/cm³.

Typically, the thermoplastic composition 10 has a flexural modulus of less than about 400,000, about 360,000, about 320,000, about 280,000, about 240,000, about 200,000, about 160,000, about 120,000, about 80,000, about 70,000, about 60,000, about 50,000, about 40,000, about 30,000, about 20,000, about 10,000, psi when tested in accordance with ASTM D-790.

As used herein, “consisting essentially of” is meant to exclude any element or combination of elements, as well as any amount of any element or combination of elements, that would alter the basic and novel characteristics of the thermoplastic composition 10 such as fillers, plasticizers, and polyamides. In one embodiment, the thermoplastic composition 10 consists essentially of the TPU and the ceramic microspheres 12.

The thermoplastic composition 10 may be substantially free from other polymers known in the art (including POM), other fillers known in the art (including reinforcing fillers), and plasticizers known in the art. The terminology “substantially free,” as used immediately above, refers to an amount of less than 0.1, more typically of less than 0.01, and most typically of less than 0.001, parts by weight per 100 parts by weight of the thermoplastic composition 10.

### Article and Method:

As set forth above, the subject disclosure also includes an article which is formed from the thermoplastic composition 10. The article can be used in a variety of applications across a variety of industries. For example, the thermoplastic composition 10 and articles formed therefrom can be used to form safety products such as protective clothing, cut-resistant gloves, and safety glasses. As another example, the thermoplastic composition 10 and articles formed therefrom can be used in various commercial and industrial products such as cutting boards and conveyor belts.

In many embodiments, the thermoplastic composition 10 is used to form commercial and industrial products such as cutting boards and conveyor belts. In such applications, the products exhibit excellent cut-resistance, reduced drag-force, and minimize the rate of dulling of the blade 16 associated with contact between the blade 16 and the product, e.g. the conveyor belt.

In one embodiment, the article is a conveyor belt. In another embodiment, the article is a cutting board. Because the cut-resistant thermoplastic composition 10 of the subject disclosure exhibits excellent physical properties, such as tensile strength, tear strength, elongation at break, elastic modulus, flexural modulus, and cut-resistance and reduced drag-force over a wide range of temperatures and also functions to reduce the rate of blade 16 dulling upon contact between the blade 16 (e.g. from cutting equipment such as a knife, guillotine, or die) and the article (e.g. a conveyor belt), the article is durable, long lasting, and can reduce physical stresses on an operator and/or the cutting equipment.

In addition to the thermoplastic composition 10 and the article formed therefrom, the instant disclosure also provides a method of cutting an object on an article formed from the cut-resistant thermoplastic composition 10. The method includes the steps of (1) providing the article comprising the thermoplastic composition 10, and (2) cutting the object on the article with the blade 16.

In a typical embodiment, the article is a cutting board or a conveyor belt. The blade 16 is typically metal and part of a cutting tool such as a knife, guillotine, or die (e.g. a die-cutting board). In one embodiment, the article is a conveyor belt having a thickness of from about 0.1 to about 20, or from about 0.5 to about 8, mm.

In one typical embodiment, the object is a food stuff such as meat, gum, etc. In another typical embodiment, the article is a product comprising a polymeric material such as rubber or thermoplastic, e.g. a rubber kitchen mat.

The method optionally includes the step of forming the article with the thermoplastic composition 10. The article can be formed with a variety of techniques, including but not limited to, extrusion, vacuum forming, die cutting, and injection molding. The article can be a conveyor belt or any other cutting surface comprising and/or formed from the thermoplastic composition 10.

The present invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that within the scope of the appended claims, the present invention may be practiced otherwise than as specifically described.

### EXAMPLES

A series of articles are formed with the thermoplastic composition of this disclosure. More specifically, Examples 1-12 comprising the thermoplastic composition were formed by first incorporating the ceramic particles into the thermoplastic composition via twin-screw compounding and then extruding the thermoplastic composition into 2-mm-thick, 6-inch-wide test sheets via single screw extrusion for Cut Depth experiments or injection molding into 4″×4″×2 mm plaques for Drag Force experiments. The formulas of Examples 1-12 and Comparative Examples 1-3 are set forth in Table 2 below, with the component amount in parts by weight based on 100 parts by weight of the thermoplastic composition.

TABLE 1

| | | | | | | | | | Cut Depth**, | |
|---|---|---|---|---|---|---|---|---|---|---|
| | | | | | | | | | Relative | Drag |
| | | | | | | | | | to Comparative | Force***, Relative |
| | | | | | | | | Cut Depth | Example 1 | to Comparative |
| | Polymer A | Polymer B | Polymer C | Polymer D | Polymer E | Ceramic A | Ceramic B | (micron)* | (%) | Example 1 (%) |
| Comparative | — | — | — | 100% | — | — | — | 270 | 100% | 100% |
| Example 1 | | | | | | | | | | |
| Comparative | 100% | — | — | — | — | — | — | Completely | — | — |
| Example 2 | | | | | | | | cut through | | |
| | | | | | | | | in about 300 | | |
| | | | | | | | | revolutions | | |
| Comparative | — | 100% | — | — | — | — | — | Completely | — | — |
| Example 3 | | | | | | | | cut through | | |
| | | | | | | | | in about 200 | | |
| | | | | | | | | revolutions | | |
| Example 1 | 90% | — | — | — | — | — | 10% | 1800 | 667% | — |
| Example 2 | 95% | — | — | — | — | 5% | — | 800 | 296% | — |
| Example 3 | 90% | — | — | — | — | 10% | — | 750 | 278% | — |
| Example 4 | 80% | — | — | — | — | 20% | — | 230 | 85% | 29% |
| | | | | | | | | | (cut- | (drag- |
| | | | | | | | | | resist, | force |
| | | | | | | | | | gradient = | gradient = |
| | | | | | | | | | 15%) | 71%) |
| Example 5 | — | 90% | — | — | — | — | 10% | — | — | — |
| Example 6 | — | 90% | — | — | — | 10% | — | — | — | — |
| Example 7 | — | — | — | 80% | — | 20% | — | TBD | TBD | TBD |
| Example 8 | — | — | — | 70% | — | 30% | — | TBD | TBD | TBD |
| Example 9 | 80% | — | — | — | — | 20% | — | 230 | 85% | 29% |
| (Example 4 | | | | | | | | | (cut- | (drag- |
| repeat) | | | | | | | | | resist. | force |
| | | | | | | | | | gradient = | gradient = |
| | | | | | | | | | 15%) | 71%) |
| Example 10 | 70% | — | — | — | — | 30% | — | TBD | TBD | TBD |
| Example 11 | — | — | — | 100% | — | — | — | TBD | TBD | TBD |
| Example 12 | — | — | 50% | — | 30% | 20% | — | 313 | 116% | 73% |

*Tested for 1,000 revolutions with a 2 lb-f applied load.
**/***The test methods for evaluating the cut-resistance** and drag-force*** of the thermoplastic composition of the subject disclosure is described above and depicted schematically in FIGS. 3 and 4.

Polymer A is a polyether based thermoplastic polyurethane having a durometer of 74 Shore D when tested according to ASTM 2240; a density of 1.19 g/cm³ when tested in accordance with ASTM D-792, a vicat softening temperature of 160° C. when tested in accordance with ASTM D-1525, a tensile modulus of 7,100 psi when tested in accordance with ASTM D-412, and a flexural modulus of 73,000 psi when tested in accordance with ASTM D-412.

Polymer B is a polyether based thermoplastic polyurethane having a durometer of 85 Shore A when tested according to ASTM 2240; a density of 1.12 g/cm³ when tested in accordance with ASTM D-792, a vicat softening temperature of 100° C. when tested in accordance with ASTM D-1525, a tensile modulus of 5,200 psi when tested in accordance with ASTM D-412, and a flexural modulus of 4,200 psi when tested in accordance with ASTM D-412.

Polymer C is a polyether based thermoplastic polyurethane having a durometer of 54 Shore D when tested according to ASTM 2240; a density of 1.16 g/cm³ when tested in accordance with ASTM D-792, a vicat softening temperature of 138° C. when tested in accordance with ASTM D-1525, a tensile modulus of 7,000 psi when tested in accordance with ASTM D-412, and a flexural modulus of 24,000 psi when tested in accordance with ASTM D-412.

Polymer D is a high molecular weight polyoxymethylene having a density of 1.4 g/cm³ when tested in accordance with ASTM D-792, a vicat softening temperature of 150° C. when tested in accordance with ISO 306, a melting point of 165° C. when tested in accordance with DIN 53765, a tensile strength of 64 MPa when tested in accordance with ISO 527-2, and a flexural modulus of 358,000 psi when tested in accordance with ASTM D-790. Example 11 is an injection molding grade of the same material.

Polymer E is a polybutylene terephthalate having a density of 1.4 g/cm³ when tested in accordance with ASTM D-792, a vicat softening temperature of 150° C. when tested in accordance with ISO 306, a melting point of 167° C. when tested in accordance with DIN 53765, a tensile strength of 65 MPa when tested in accordance with ISO 527-2, and a flexural modulus of 358,000 psi when tested in accordance with ASTM D-790.

Ceramic A is a solid ceramic microsphere having a particle size of D90-28 μm, D50-10 μm, and D10-1 μm, a hardness of 6 on the Mohs scale, and a crush strength of greater than 4,200 kg/m².

Ceramic B is a solid ceramic microsphere having a particle size of D90-15 μm, D50-4 μm, and D10-1 μm, a hardness of 6 on the Mohs scale, and a crush strength of greater than 4,200 kg/m².

Referring now to Table 2, Examples 4 and 9 which comprise Polymer A (TPU) and Ceramic Microsphere A at a loading of 20% by weight significantly outperform Comparative Examples 2 and 3 (TPU without ceramic microspheres) and Comparative Example 1 (POM without ceramic microspheres—an industry standard for conveyor belts) with respect to cut-resistance. A loading of greater than about 20% by weight of the larger particle size ceramic microspheres in Example 4 yields better performance than Comparative Example 1 and the best cut-resistance of all of the Examples tested.

It is to be understood that the appended claims are not limited to express any particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that within the scope of the appended claims, the present invention may be practiced otherwise than as specifically described.

1. A cut-resistant thermoplastic composition cc uprising:
(A) a polymer; and
(B) ceramic microspheres having a D90 particle size of from about 20 to about 80 μm, a D50 particle size of from about l to about 15 μm, and/or a D10 particle size of about 1 μm, and present in an amount of from about 5 to about 50 weight percent, based on 100 parts by weight of said thermoplastic composition; wherein said thermoplastic composition has a cut--resistance gradient of greater than about 15%.

2. A cut-resistant thermoplastic composition as set forth in claim 1 wherein said ceramic microspheres have a D90 particle size of from about 5 to about 35 μm.

3. A cut-resistant thermoplastic composition as set forth in claim 1 wherein said ceramic microspheres are present in an amount of from about 15 to about 35 weight percent, based on 100 parts by weight of said thermoplastic composition.

4. A cut-resistant thermoplastic composition as set forth in claim 1 wherein said ceramic microspheres have a specific gravity of from about 2.2 to about 2.6 g/cm³.

5. A cut-resistant thermoplastic composition as set forth in claim 1 wherein said ceramic microspheres have a crush strength of greater than about 4,200 kg/cm².

6. A cut-resistant thermoplastic composition as set forth in claim 1 wherein said polymer is selected from a thermoplastic polyurethane, a polyoxymethylene, a polyalkylene terephthalate, and combinations thereof.

7. A cut-resistant thermoplastic composition as set forth in claim 6 comprising said thermoplastic polyurethane selected from the group of polyether-based thermoplastic polyurethanes, polyester-based thermoplastic polyurethanes, and combinations thereof.

8. A cut-resistant thermoplastic composition as set forth in claim 7 wherein said thermoplastic polyurethane is a polyether-based thermoplastic polyurethane.

9. A cut-resistant thermoplastic composition as set forth in claim 7 wherein said thermoplastic polyurethane has a weight average molecular weight of greater than about 50,000 g/mol.

10. A cut-resistant thermoplastic composition as set forth in claim 7 wherein said thermoplastic polyurethane has a tensile strength of from about 2,000 to about 80,000 psi at 23° C. as determined by ASTM D412.

11. A cut-resistant thermoplastic composition as set forth in claim 6 comprising said polyoxymethylene.

12. A cut-resistant thermoplastic composition as set forth in claim 11 wherein said polyoxymethylene has a weight average molecular weight of greater than about 25,000 g/mol.

13. A cut-resistant thermoplastic composition as set forth in claim 6 comprising said polyalkylene terephthalate wherein said polyalkylene terephthalate is selected from polyethylene terephthalate, polybutylene terephthalate, polytrimethylene terephthalate, and combinations thereof.

14. A cut-resistant thermoplastic composition as set forth in claim 13 comprising polybutylene terephthalate.

15. A cut-resistant thermoplastic composition as set forth in claim 13 wherein said polyalkylene terephthalate has a weight average molecular weight of greater than about 25,000 g/mol.

16. A cut-resistant thermoplastic composition as set forth in claim 1 having a flexural modulus of less than about 400,000 psi at 23° C. as determined by ASTM D790.

17. A cut-resistant thermoplastic composition as set forth in claim 1 having a drag-force gradient of greater than about 15%.

18. A cut-resistant thermoplastic composition as set forth in claim 1 having specific gravity of from about 1.05 to about 1.95 g/cm³.

19. A conveyor belt comprising said cut-resistant thermoplastic composition set forth in claim 1.

20. A method of cutting an object on an article formed from the cut-resistant thermoplastic composition set forth claim 1, said method comprising the steps of:
(1) providing the article comprising the thermoplastic composition: and
(2) cutting the object on the article with a blade.
